(19) United States
(12) Patent Application Publication
(10) Pub. No.: US 2020/0394633 A1
(43) Pub. Date: Dec. 17, 2020

(54) A TRANSACTION PROCESSING SYSTEM AND METHOD

(71) Applicant: SAFE2PAY PTY LIMITED, Sydney, New South Wales (AU)

(72) Inventors: Schaan O'Hara, Willoughby, New South Wales (AU); Admir Nasic, Mascot, New South Wales (AU)

(21) Appl. No.: 16/472,737

(22) PCT Filed: Dec. 21, 2017
(86) PCT No.: PCT/AU2017/051440

§ 371 Date: Jun. 21, 2019

(30) Foreign Application Priority Data
Dec. 21, 2016 (AU) 2016905309

(51) Int. Cl. G06Q 20/20; G06F 16/23; G06Q 20/38; G06Q 20/02

(52) U.S. Cl. CPC G06Q 20/202; G06F 16/2379; G06Q 20/02; G06Q 20/385; G06Q 20/204

(57) ABSTRACT

The present invention relates to a transaction processing system and processing method for dealing with payment transactions, generally, but not exclusively, at point of sale. A transaction processing system is arranged to provide a token in place of an usual account identifier (such as a credit card or debit card) for provision to a point of sale device, and to generate and provide a non-transactional message to the point of sale device. The non-transactional message instructs an acquiring system associated with the point of sale device to transfer the token to the transaction processing system. The transaction processing system de-tokenises the token and passes it back to the acquiring system, together with a transaction message. The acquiring system then processes the transaction as usual.

### FIELD OF THE INVENTION

The present invention relates to a transaction processing system and transaction processing method and, particularly, but not exclusively, to a transaction processing system and method for dealing with transactions over networks.

### BACKGROUND OF THE INVENTION

It is well known to provide transaction information and messaging over computer networks for processing of transactions for payment for goods and services. For example, it is known to use debit card and credit card details at point of sale to pay for product (goods and/or services). The credit card or debit card details (“account identifier details”) are provided to the point of sale device (“POS device”). The account identifier, together with transaction and processing messages generated by the POS device, are then passed on to a payment network. The payment network then deals with the rest of the transaction processing, usually via acquirer and issuer banks, and the transaction is settled (payment is made).

Current transaction processing arrangements have problems with security. Where a person or organisations' account identifier (e.g. credit card or debit card number) is placed on a computer network, there is the potential for misappropriation of the account identifier and fraudulent use.

Systems and methods are known for replacing account identifiers with “tokens”. The token may be in the same format as the account identifier or a different format. The token is used during transaction messaging over the network and is detokenised in order to settle the transaction. Use of tokenisation in transactional processing is intended to limit the potential for fraud. Many of the current tokenisation techniques are extremely complex and difficult to implement. They require many parties to collaborate in the provisioning of tokens and detokenisation, and transaction processing.

Australian patent no. 776025 (Safepay Australia Pty Ltd) discloses a system and method of tokenisation which involves the generation of a “once only” number (or other type of token) to replace the account identifier during at least part of transaction processing. The contents of Australian patent no. 776025 are incorporated herein by reference in their entirety.

### SUMMARY OF INVENTION

In accordance with a first aspect, the present invention provides a system for dealing with transactions over a computer network, comprising a transaction processing system arranged to provide a token in place of an account identifier for provision to a point of sale device, and to provide a non-transactional message to the point of sale system and to instruct an acquiring system to pass the token to the transactional processing system for de-tokenisation.

In an embodiment, the transaction processing system is a computing system.

Typically, point of sale devices receive transaction identifiers from devices (e.g. chip cards, magnetic stripe cards, mobile smartphones) and pass the transaction identifier onto a payment transaction network for processing. The POS device usually generates messaging to facilitate processing of the transaction. This transaction messaging is passed between various computing systems in a transaction processing network to facilitate processing and settlement of the transaction.

A POS device may form part of a POS system, which may also include a host computing system, e.g. associated with the POS premises. In a typical transaction process, the POS system will normally transmit the transaction details (in the form of transaction messages) and account identifier to an acquiring system (e.g. computing system of a transaction acquirer) associated with the merchant. The acquirer then may on forward the transaction details to an issuer via the transaction processing network, for settlement of the transaction.

In an embodiment, the non-transactional message provided by the transaction processing system indicates to a computing system receiving the non-transactional message and the token, that this is not for a transaction. Instead, it causes the receiving computing system (the “acquiring system”) to pass the token to the transactional processing system for de-tokenisation.

In an embodiment, the token may include, as part of the token, a host identifier, that identifies the transaction processing system as the host. This enables the acquiring system to know where to send the token for de-tokenisation (i.e. to the transaction processing system).

When the TPS (transaction processing system) receives the token, it de-tokenises and provides the actual account identifier (e.g. credit card number). In an embodiment, it provides the account identifier back to the acquiring system together with a transactional processing message which instructs the acquiring system that this is a transaction to be processed. The transaction is then processed as per normal, via the payment network.

It is an advantage of at least an embodiment, that the system enables tokenisation with minimal interference with a typical transaction processing network. Use of the transaction messaging generated by the TPS can direct already existing computer processes to direct back to the TPS for de-tokenisation, with minimal effect on the existing computing processes of the transaction processing network, acquiring systems and issuing systems.

In accordance with a second aspect, the present invention provides a method of dealing with the transaction over a computer network, comprising the steps of:

providing a token in place of an account identifier to a point of sale system;

providing a non-transactional message to the point of sale system; instructing the point of sale device to provide the token to an acquiring computing system;

instructing the acquiring computing system to pass the token to the transaction processing system for de-tokenisation.

In accordance with a third aspect, the present invention provides a method of dealing with a transaction over a computer network, comprising the steps of generating a message for provision to a point of sale system together with a token for a transaction, the message directing a computing system associated with the POS device to forward the token to a transaction processing system for de-tokenisaton.

In an embodiment, the message is a non-transactional message.

In accordance with a fourth aspect, the present invention provides a system for dealing with transactions over a computer network, comprising a transaction processing system arranged to provide a token in place of an account identifier for provision to an online sales processor, and to provide a non-transactional message to the online sales processor, and to instruct an acquiring system to pass the token to the transactional processing system for de-tokenisation.

In accordance with a fifth aspect, the present invention provides a method of dealing with a transaction over computer network, comprising the steps of providing a token in place of an account identifier to an on-line sales processor; providing a non-transactional message to the on-line sales processor, instructing the on-line sales processor to provide the token to an acquiring computing system; instructing the acquiring computing system to pass the token to the transaction processing system for de-tokenisation.

In accordance with a sixth aspect, the present invention provides a computer program, comprising instructions for controlling a computer to implement a system in accordance with a first aspect or the fourth aspect of the invention.

In accordance with a fifth aspect, the present invention provides a computer readable medium, providing a computer program in accordance with the sixth aspect of the system.

In accordance with a sixth aspect, the present invention provides a computer media signal, comprising a computer program in accordance with the sixth aspect of the invention.

In this document “acquiring system” refers to a computing system associated generally with a entity which is also associated with the POS device. It doesn't necessarily mean an acquiring system in the sense generally used in transaction processing (i.e. “transaction acquirer”). The acquiring system may be associated with the transaction acquirer, however.

### BRIEF DESCRIPTION OF THE FIGURES

Features and advantages of the present invention will become apparent from the following description of embodiments thereof, by way of example only, with reference to the accompanying drawings in which;

FIG. 1 is a schematic diagram of a transaction processing system in accordance with an embodiment of the present invention, together with other systems in a payment transaction network, and

FIG. 2 is a flow diagram of a transaction process implemented in accordance with an embodiment of the present invention.

### DETAILED DESCRIPTION OF EMBODIMENTS

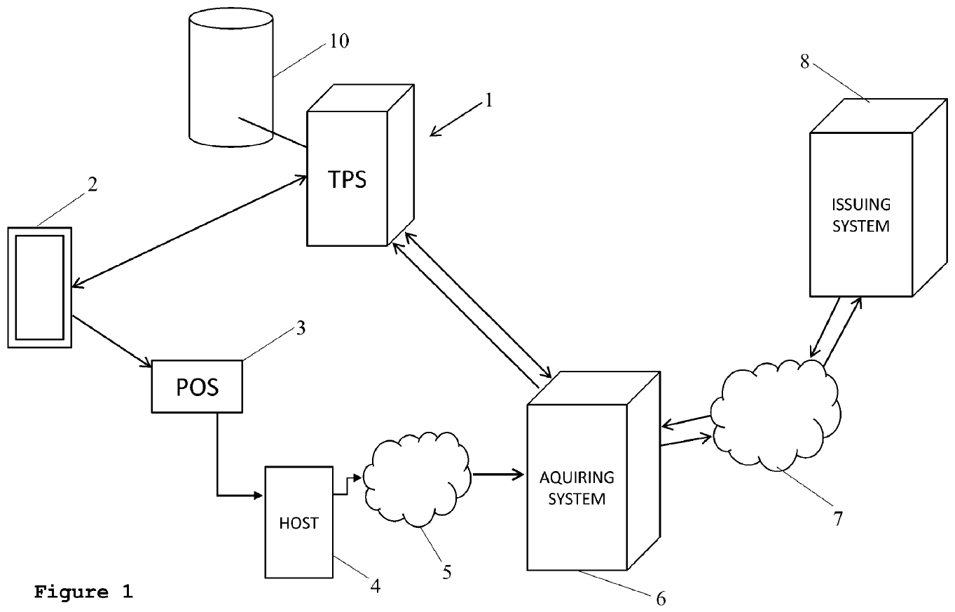

Referring to FIG. 1, a system for dealing with dealing transactions over a computer network is illustrated, comprising a transaction processing computing system (TPS) System 1. In this example the TPS 1 is shown as a computer server device, but it is not limited to this. The TPS 1 may comprise any computer infrastructure, it may be housed in the Cloud, it may comprise a main frame, terminal architecture client server or any other computer architecture.

The TPS 1 is arranged to communicate with a user device 2. The user device 2 may be any computing device, such as a mobile computing device, such as a smart phone, tablet, or any other type of computing device.

The TPS 1 and/or device 2 (which can be considered to be part of the TPS) generates and provides a token in place of an account identifier, when the user 2 indicates via their device that they wish to undertake a transaction. The user may be at point of sale, for example, in a store, wishing to purchase goods or services (or any product).

The token may be provided in accordance with the system disclosed in the Safepay Patent Australian patent no. 776025 referenced above. Generation of the token is not limited to this system, however.

The token and a non-transaction message generated by the TPS 1, 2 is provided to a POS device 3. The POS device is a device which is arranged to generate and pass on messages relating to transactions, including passing on account identifiers and/or tokens. In this embodiment, the POS device 3 may be associated with a host computing system 4 to form a POS system 3, 4. The non-transactional message is passed on to the host 4 and then via a computer network 5 (e.g. the internet) to a acquiring system 6.

The acquiring system recognises the non-transaction message and diverts the token to the TPS 1. The TPS 1 de-tokenises and passes back the account identifier to the acquiring system, together with a transaction message.

The transaction then may be settled as usual. In the embodiment shown in FIG. 1, the acquiring system may pass the transaction information to a payment network 7. The payment network may identify the issuer (e.g. credit card issuer) and forward to an issuing system 8 associated with the issuer. The issuer may then settle the transaction and advise the acquiring system 6 who may also advise the TPS 1. Note that the acquiring system 6 may also be associated with an issuer, in which case the acquiring system, as the issuer, will settle the transaction.

In more detail, the transaction processing system 1 is arranged to maintain a database 10. The database 10 includes account details of users of the TPS. The account details may include information about the user, such as name, address, and account details. The account details may include details of account identifiers. For example, credit card numbers, debit card numbers or other account identifiers. When a token is generated the TPS 1 is arranged to associate the token with the user account details of the particular user, to enable subsequent de-tokenisation.

When a user indicates via their device 2 that they wish to undertake a transaction, a token is generated and associated with the user account details in the database 10.

Generation of the token in this embodiment takes place in accordance with the process described in the Safepay Australian patent no. 776025. The token may be generated by an application (e.g. a native application) on the device 2, or may be generated by the TPS 1 and the token provided to the device 2. If the token is generated on the device 2, the token is passed to the TPS 1 so that it can be associated with the user account details on the database 10. Otherwise, if the TPS 1 generates the token, it automatically associates the token with the user account details 10.

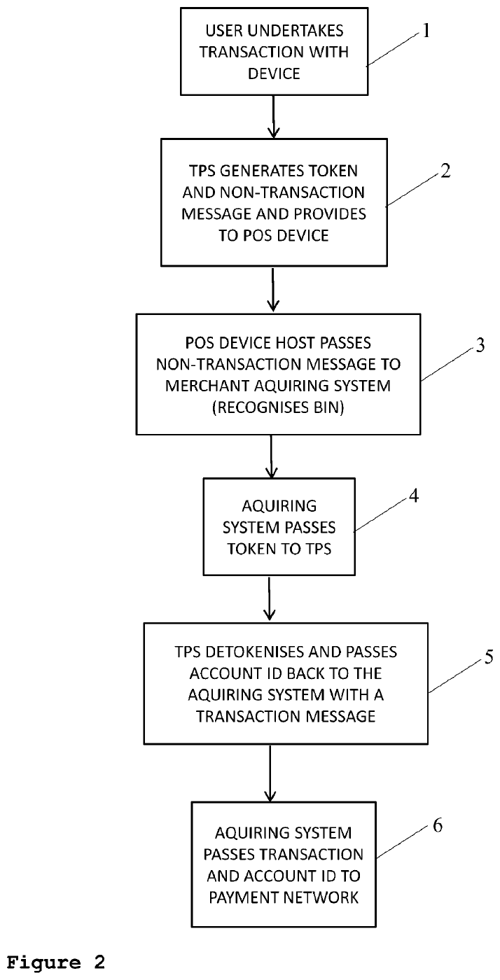

In addition, either an application on the user device 2 or the TPS 1 generates a non-transaction message to be passed to the POS device 3 with the token. See steps 1 and 2 of FIG. 2.

The token may be any type of token. It may include a biometric. It may be a number, or it may be any key. In this embodiment, the token is a number in the same format as the account identifier. For example, where the account identifier is a credit card number, the token is generated in the same format as the credit card number.

In this embodiment, the token includes a BIN identifier. BIN identifiers are used in normal account numbers (debit and credit card). In this embodiment the BIN is associated with the transaction processing system, in the sense that it enables the acquiring system to identify the TPS 1 and direct the token to the TPS 1 for de-tokenisation. The BIN also identifies the acquiring system 6 as the BIN “host” in this embodiment. The acquiring system may be administered by a financial institution or other institution, such as a bank, for example. Although the BIN is associated with the TPS, the BIN may also be associated with the acquiring system 6. The acquiring system may be known as the BIN “host”. In normal transaction processing the POS 3 and host 4 may identify the BIN and forward the transaction messaging and token to an issuing system associated with the BIN. That is, it may not necessarily be sent to the acquiring system 6 which is associated with the POS device 3. In this embodiment of the invention, however, the acquiring system 6 has a relationship with the TPS 1, the BIN identifies the acquiring system as the host system for the BIN and therefore the POS device 3 in a host system 4 for the POS device transmits the via the network 5, the transaction messaging and token to the acquiring system 6. See item 3 of FIG. 2.

A non-transaction message indicates to the acquiring system 6 that the message is not associated with a transaction.

The acquiring system 6 recognizes the BIN as associated with the TPS 1. It is also instructed by the non-transaction message that it is not receiving a normal transaction message. The acquiring system 6 therefore understands to pass the token to the TPS 1 for de-tokenisation. See step 4 of FIG. 2.

At step 5, the TPS 1 de-tokenises the token by reference to the database 10 and obtains the account identifier, which is passed back to the acquiring system 6, together with a transaction message indicating that the token is associated with a transaction. The acquiring system 6 can then settle the transaction in the normal way. See step 6. In FIG. 1, the acquiring system may pass the transaction messaging, including the transaction details and the account identifier via a payment network 7 to an issuing system (e.g. hosted by an issuing bank) 8. The issuing system 8 may settle the transaction (by checking the user's account details against the credit and making payment). Confirmation of payment may be passed back to the acquiring system 6 and also back to the TPS 1 from the acquiring system 6. Note that the acquirer system may in some circumstances be an issuer as well, in which case it will settle the transaction.

An advantage of this embodiment, is that the acquiring system 6 does not have to significantly alter their computing systems or transaction processing methodology. The BIN in the token identifies the TPS 1. Once the acquiring system 6 receives the de-tokenised account identifier back from the TPS 1, the transaction proceeds as normal.

In the above embodiment, the device 2 interacts with a point of sale (POS) system. The POS system may be in-store, or in any location. In an alternative embodiment, a system and method of the present invention can be used for on-line purchases. The non-transactional message will be provided to the processor processing the on-line transaction.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1-10. (canceled)

11. A system for dealing h transactions over a computer network, comprising a transaction processing system arranged to provide a token in place of an account identifier for provision to a point of sale device, and to provide a non-transactional message to the point of sale system and to instruct an acquiring system to pass the token to the transactional processing system for de-tokenization.

12. A system in accordance with claim 11, wherein the transaction processing system is arranged to de-tokenize the token and generate a transaction message, and pass the token and transaction message back to the acquiring system.

13. A method of dealing with a transaction over a computer network, comprising the steps of:
providing a token in place of an account identifier to a point of sale system;
providing a non-transactional message to the point of sale device;
instructing the point of sale device to provide the token to an acquiring computer system; and
instructing the acquiring computing system to pass the token to the transaction processing system for de-tokenization.

14. A method in accordance with claim 13, comprising the further steps of the transaction processing system de-tokenizing the token, generating a transactional message, and passing the token and transactional message back to the acquiring system.

15. method of dealing with a transaction over a computer network, comprising the steps of:
providing a token in place of an account identifier to an on-line sales processor;
providing a non-transactional message to the on-line sales processor;
instructing the on-line sales processor to provide the token to an acquiring computer system; and
instructing the acquiring computer system to pass the token to the transaction processing system for de-tokenization.
